(19) United States
(12) Patent Application Publication
(10) Pub. No.: US 2010/0238061 A1
(43) Pub. Date: Sep. 23, 2010

(54) Remote Control Method and Related Apparatus for a Computer System

(76) Inventor: Chung-Chia Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/491,254

(22) Filed: Jun. 25, 2009

(30) Foreign Application Priority Data
Mar. 23, 2009 (TW) 098109403

(51) Int. Cl. H04L 17/02; G08B 29/00

(52) U.S. Cl. 341/176; 340/5.51

(57) ABSTRACT

A remote control method for a computer system includes receiving a remote control signal including a control command, checking validity of the remote control signal to generate a check result when the control command is utilized for switching the computer system from a first operating mode to a second operating mode, and switching the computer system from the first operating mode to the second operating mode when the check result indicates that the remote control is valid.

### BACKGROUND OF THE INVENTION

1. Field of the Invention

The present invention relates to a remote control method and related apparatus for a computer system, and more particularly, to a remote control method and related apparatus capable of maintaining safety and convenience simultaneously.

2. Description of the Prior Art

With advancements in electronic technology, a computer system has become part of modem life. In order to allow a user to conveniently manipulate each function of the computer system, the prior art has developed a remote control computer system, allowing the user to manipulate the computer system via a remote controller.

Generally speaking, communication technologies used in the remote controller are infrared or wireless radio frequency transmission technologies. The wireless radio frequency transmission technology is omnidirectional, but is power-consumed and complicated in implementation. An infrared remote controller has characteristics of small volume, low power consumption, high security, low production cost, etc., such that the infrared remote controller has become the most popular remote control device. For example, please refer to FIG. 1, which is a schematic diagram of a prior art notebook 10 with an infrared remote control function. In the notebook 10, when the user wants to execute a specific function of the notebook 10 such as media player control, mouse cursor movement, power on, shut down, etc., the user can press a corresponding key of a remote controller 100, so the remote controller 100 outputs a corresponding control signal to an infrared receiver 102 via the infrared transmission, to perform related functions. For example, when the user wants to boot the notebook, the user can press a key 104 of the remote control 100.

Via the infrared remote control method, the user can manipulate functions of the notebook 10 remotely, so as to enhance convenience. However, if the notebook 10 has been set a boot password, meaning that a basic input output system (BIOS) of the notebook 10 asks the user to enter the boot password when the notebook 10 is powered on, and continues the power-on process when the password is correct. Under such circumstances, the notebook 10 will wait for the user to enter the password, which causes the remote controller 100 incapable of reaching the expected power-on function.

In short, the remote control function of the computer system of the prior art cannot cover convenience and security at the same time, and the related improvement is necessary.

### SUMMARY OF THE INVENTION

It is therefore a primary objective of the claimed invention to provide a remote control method and related apparatus for a computer system.

The present invention discloses a remote control method for a computer system, the remote control method comprises receiving a remote control signal having a control command; checking validity of the remote control signal to generate a check result when the control command is utilized for switching the computer system from a first operating mode to a second operating mode; and switching the computer system from the first operating mode to the second operating mode when the check result indicates that the remote control is valid.

The present invention further discloses a remote control signal receiver for a computer system, the remote control signal receiver comprises a receiving unit for receiving a remote control signal having a control command; a checking unit for checking validity of the remote control signal to generate a check result when the control command is utilized for switching the computer system from a first operating mode to a second operating mode; and a control unit for switching the computer system from the first operating mode to the second operating mode when the check result indicates that the remote control is valid.

The present invention further discloses a remote control method for a computer system, the remote control method comprises receiving a control signal utilized for switching the computer system from a first operating mode to a second operating mode; generating a control command according to the control signal; retrieving a verification code; generating a remote control signal according to the control command and the verification code; and transmitting the remote control signal to the computer system, for switching the computer system from the first operating mode to the second operating mode.

The present invention further discloses a remote control signal transmitter for a computer system, the remote control signal transmitter comprises a key for receiving a control signal utilized for switching the computer system from a first operating mode to a second operating mode; a control command generating unit for generating a control command according to the control signal; a verification code retrieving unit for retrieving a verification code; a remote control signal generating unit for generating a remote control signal according to the control command and the verification code; and a transmitting unit for transmitting the remote control signal to the computer system, for switching the computer system from the first operating mode to the second operating mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a prior art notebook with infrared remote control function.

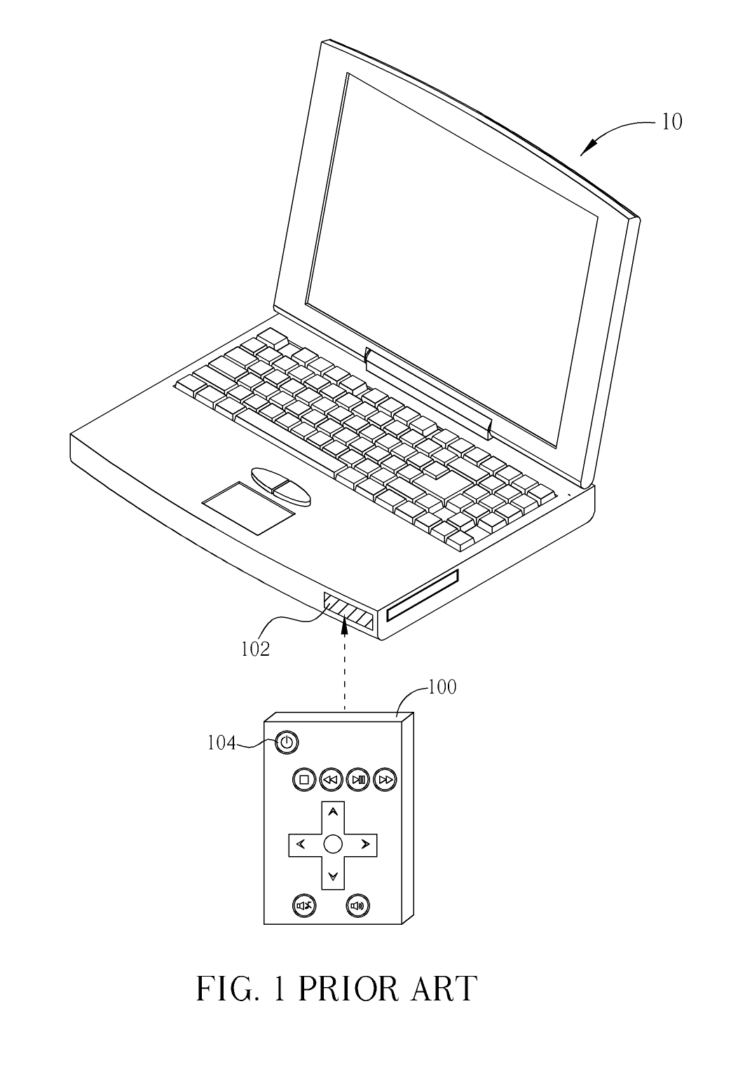

FIG. 2A is a schematic diagram of a computer system with infrared remote control function according to an embodiment of the present invention.

FIG. 2B is a functional block diagram of an infrared remote control system shown in FIG. 2A.

FIG. 3 is a flow chart of a remote control signal transmitter shown in FIG. 2B.

FIG. 4 is a flow chart of a remote control signal receiver shown in FIG. 2B.

### DETAILED DESCRIPTION

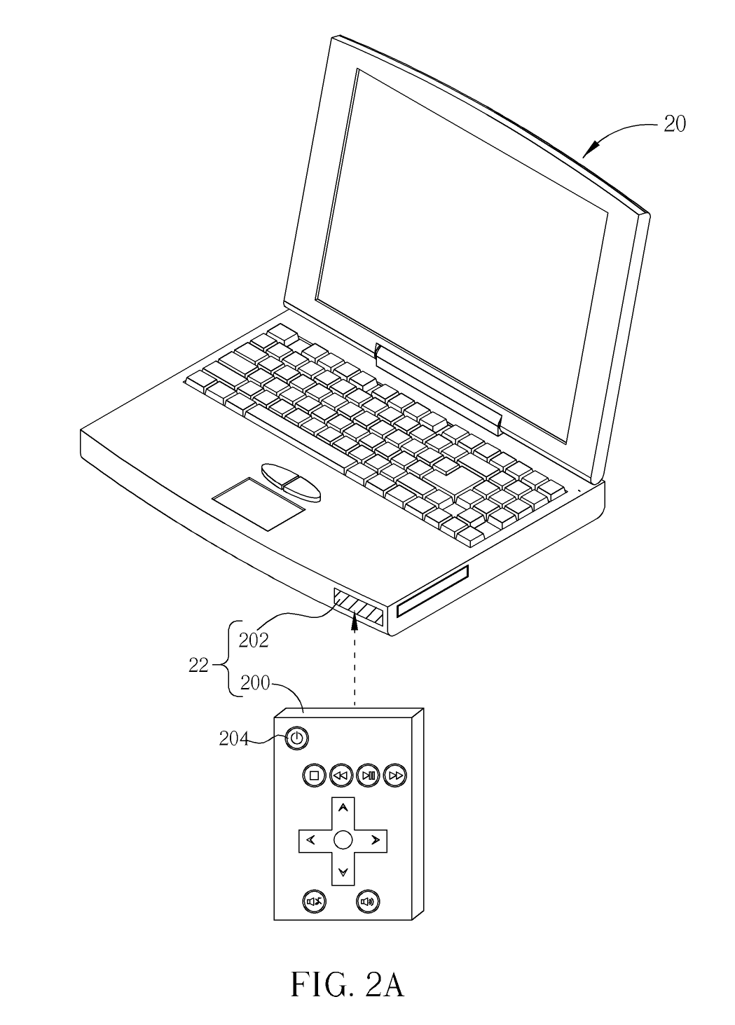

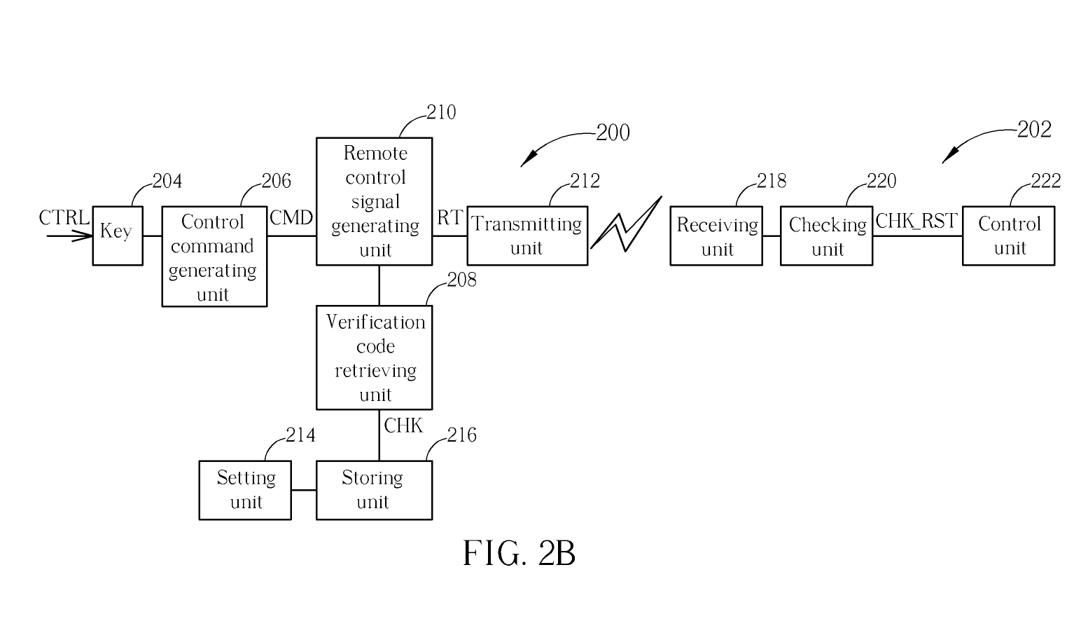

Please refer to FIG. 2A, which is a schematic diagram of a computer system 20 having an infrared remote control function according to an embodiment of the present invention. The computer system 20 comprises an infrared remote control system 22, which allows a user to manipulate functions of the computer system 20 via an infrared remote control method. The infrared remote control system 22 comprises a remote control signal transmitter 200 and a remote control signal receiver 202. When the user needs to execute a specific function of the computer system 20 such as media player control, mouse cursor movement, power on, shut down, etc., the user can press a corresponding key of a remote control signal transmitter 200, so the remote control signal transmitter 200 outputs a corresponding control signal to a remote control signal receiver 202 via the infrared transmission, to perform related functions. For example, when the user wants to boot the computer system 20, the user can press a key 204 of the remote control signal transmitter 200. Under such circumstances, even if a basic input output system (BIOS) of the computer system 20 has been set a boot password, the present invention can still boot the computer system 20 correctly, for enhancing convenience.

Please continue to refer to FIG. 2B, which is a functional block diagram of the infrared remote control system 22 shown in FIG. 2A. In FIG. 2B, except for the key 204, the remote control signal transmitter 200 further comprises a control command generating unit 206, a verification code retrieving unit 208, a remote control signal generating unit 210, a transmitting unit 212, a setting unit 214, and a storing unit 216. The remote control signal receiver 202 comprises a receiving unit 218, a checking unit 220, and a control unit 222. Operations of the infrared remote control system 22 are detailed below. First, if the computer system 20 has been set a boot password, the user should set the boot password as a verification code CHK via the setting unit 214, and the storing unit 216 can store the verification code CHK. After finishing the setting of the verification code CHK, if the user wants to switch the computer system 20 from a shut-down mode to a power-on mode via the remote control signal transmitter 200, the user can press the key 204 to generate a control signal CTRL. According to the control signal CTRL, the control command generating unit 206 determines that the user wants to switch the computer system 20 from the shut-down mode to the power-on mode, and then generates a corresponding control command CMD. Next, the verification code retrieving unit 208 retrieves the verification code CHK stored in the storing unit 216 and transmits the verification code CHK to the remote control signal generating unit 210. The remote control signal generating unit 210 generates a remote control signal RT according to the control command CMD and the verification code CHK, and the transmitting unit 212 transmits the remote control signal RT to the receiving unit 218 via the infrared transmission method. The receiving unit 218 retrieves the control command CMD after receiving the remote control signal RT. The control command CMD is utilized for switching the computer system 20 from the shut-down mode to the power-on mode, and consequently the checking unit 220 checks validity of the remote control signal RT, to generate a check result CHK_RST to the control unit 222. Preferably, the checking unit 220 checks whether the verification code CHK of the remote control signal RT matches the boot password, to generate the check result CHK_RST. Finally, if the check result CHK_RST indicates that the verification code CHK matches the boot password, the control unit 222 will skip a step of querying the password and directly boot the computer system 20.

Simply speaking, when the user wants to execute a power-on process of the computer system 20 via the infrared remote control system 22, the present invention carries the boot password (which is the verification code CHK) of the computer system 20 with the remote control signal RT. When the remote control signal receiver 202 receives the remote control signal RT, the checking unit 220 checks whether the verification code CHK matches the boot password. If yes, it indicates that the remote control signal RT is valid, so the control unit 222 will skip the step of querying the password and directly boot the computer system 20. On the contrary, if the verification code CHK does not match the boot password or the remote control signal RT does not comprises the verification code CHK, the remote control signal RT is determined as invalid, so the control unit 222 will not execute the power-on process of the computer system 20, which strengthens information security.

In the prior art, when the user uses a remote controller to execute the power-on process, the computer system will wait for the user to enter the password if the computer system has been set the boot password, which causes the remote controller incapable of reaching the expected function. In comparison, in the present invention, when the user presses the key 204, the remote control signal RT transmitted from the remote control signal transmitter 200 comprises the boot password of the computer system 20, so the remote control signal receiver 202 can directly execute the power-on process of the computer system 20, which enhances the convenience in practical use.

Note that, FIG. 2A and FIG. 2B illustrate the infrared remote control system 22 according to an embodiment of the present invention, and those skilled in the art can make modifications and alterations according to different requirements. For example, the computer system 20 is not limited to a notebook, and it can be a desktop computer or other type computer systems.

Besides, the checking unit 220 and the control unit 222 can be preferably implemented or integrated in BIOS of the computer system 20. On the other hand, the verification code CHK can be the same as the boot password completely, or generated by encoding the boot password. Furthermore, the transmitting unit 212 and the receiving unit 218 should match to each other, to match encoding and decoding methods, modulation and demodulation methods, operating frequency, etc.

In addition, when the user sets the verification code CHK via the setting unit 214, the user can input the verification code CHK using specific keys of the remote control signal transmitter 200, or via an application program of the computer system 20. That is, when setting the verification code CHK, the user can connect the remote control signal transmitter 200 to the computer system 20 via a transmission interface (e.g. USB), and enter the verification code CHK into the setting unit 214 via specific software, so the setting unit 214 can store the verification code CHK into the storing unit 216.

Via the present invention, even if the computer system 20 has been set the boot password, when the user presses the key 204 to boot the computer system 20, the remote control signal RT transmitted from the remote control signal transmitter 200 comprises the boot password, which allows the remote control signal receiver 202 to determine whether the remote control signal RT is valid, so as to directly control the power-on operation of the computer system 20. Therefore, the infrared remote control system 22 can have convenience and security at the same time.

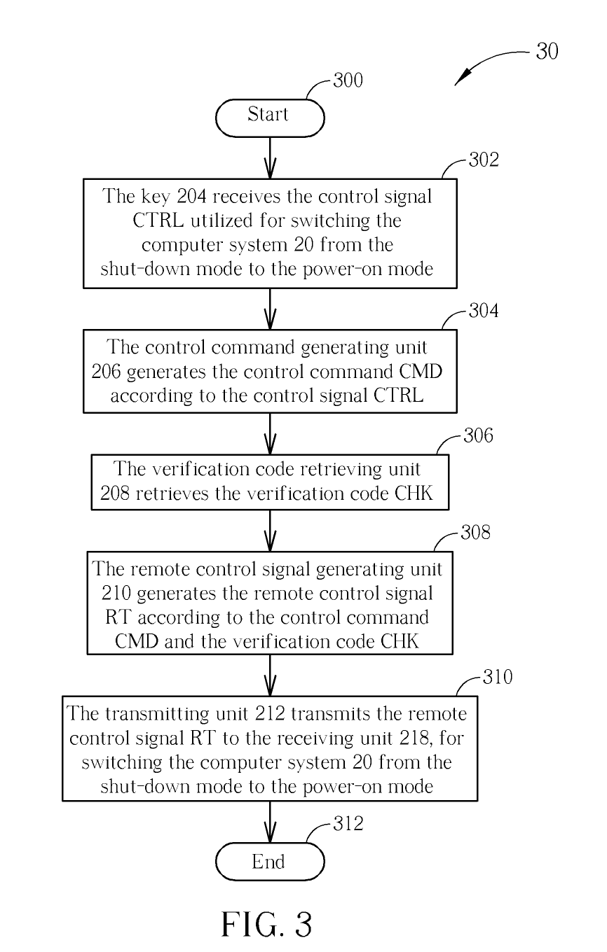

Furthermore, the operations of the remote control signal transmitter 200 can be summarized in a process 30 as shown in FIG. 3. The process 30 includes the following steps:

Step 300: Start.

Step 302: The key 204 receives the control signal CTRL utilized for switching the computer system 20 from the shut-down mode to the power-on mode.

Step 304: The control command generating unit 206 generates the control command CMD according to the control signal CTRL.

Step 306: The verification code retrieving unit 208 retrieves the verification code CHK.

Step 308: The remote control signal generating unit 210 generates the remote control signal RT according to the control command CMD and the verification code CHK.

Step 310: The transmitting unit 212 transmits the remote control signal RT to the receiving unit 218, for switching the computer system 20 from the shut-down mode to the power-on mode.

Step 312: End.

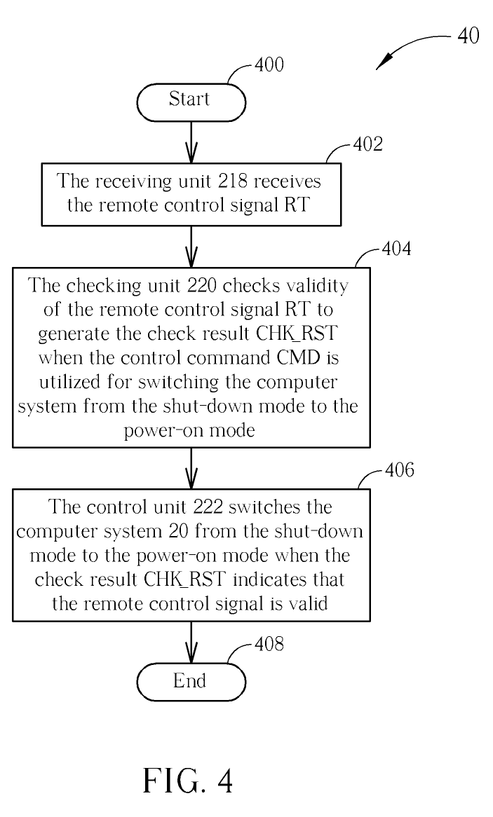

Similarly, the operations of the remote control signal receiver 202 can be summarized in a process 40 as shown in FIG. 4. The process 40 includes the following steps:

Step 400: Start.

Step 402: The receiving unit 218 receives the remote control signal RT.

Step 404: The checking unit 220 checks validity of the remote control signal RT to generate the check result CHK_RST when the control command CMD is utilized for switching the computer system from the shut-down mode to the power-on mode.

Step 406: The control unit 222 switches the computer system 20 from the shut-down mode to the power-on mode when the check result CHK_RST indicates that the remote control signal is valid.

Step 408: End.

The process 30 and the process 40 are utilized for illustrating the operations of the remote control signal transmitter 200 and the remote control signal receiver 202. Detailed operations can refer to the above description, and not narrated again herein.

To sum up, the infrared remote control system of the present invention can boot the computer system via the remote control method even if the computer system has been set the boot password, for maintaining security and convenience.

Those skilled in the art will readily observe that numerous modifications and alterations of the device and method may be made while retaining the teachings of the invention.

What is claimed is:

1. A remote control method for a computer system comprising:
receiving a remote control signal having a control command;
checking validity of the remote control signal to generate a check result when the control command is utilized for switching the computer system from a first operating mode to a second operating mode; and
switching the computer system from the first operating mode to the second operating mode when the check result indicates that the remote control signal is valid.

2. The remote control method of claim 1, wherein the step of checking validity of the remote control signal to generate the check result is comparing a verification code with a password of the computer system to generate the check result when the remote control signal comprises the verification code.

3. The remote control method of claim 2, wherein the check result indicates that the remote control signal is valid when the verification code matches the password of the computer system.

4. The remote control method of claim 2, wherein the check result indicates that the remote control signal is invalid when the verification code does not match the password of the computer system.

5. The remote control method of claim 2, wherein the check result indicates that the remote control signal is invalid when the remote control signal does not comprise the verification code.

6. A remote control signal receiver for a computer system comprising:
a receiving unit, for receiving a remote control signal having a control command;
a checking unit, for checking validity of the remote control signal to generate a check result when the control command is utilized for switching the computer system from a first operating mode to a second operating mode; and
a control unit, for switching the computer system from the first operating mode to the second operating mode when the check result indicates that the remote control signal is valid.

7. The remote control signal receiver of claim 6, wherein the checking unit is utilized for comparing a verification code with a password of the computer system to generate the check result when the remote control signal comprises the verification code.

8. The remote control signal receiver of claim 7, wherein the check result indicates that the remote control signal is valid when the verification code matches the password of the computer system.

9. The remote control signal receiver of claim 7, wherein the check result indicates that the remote control signal is invalid when the verification code does not match the password of the computer system.

10. The remote control signal receiver of claim 7, wherein the check result indicates that the remote control signal is invalid when the remote control signal does not comprise the verification code.

11. A remote control method for a computer system comprising:
receiving a control signal utilized for switching the computer system from a first operating mode to a second operating mode;
generating a control command according to the control signal;
retrieving a verification code;
generating a remote control signal according to the control command and the verification code; and
transmitting the remote control signal to the computer system, for switching the computer system from the first operating mode to the second operating mode.

12. A remote control signal transmitter for a computer system comprising:
a key means for receiving a control signal utilized for switching the computer system from a first operating mode to a second operating mode;
a control command generating unit means for generating a control command according to the control signal;
a verification code retrieving unit means for retrieving a verification code;
a remote control signal generating unit means for generating a remote control signal according to the control command and the verification code; and
a transmitting unit means for transmitting the remote control signal to the computer system so as to switch the computer system from the first operating mode to the second operating mode.

13. The remote control signal transmitter of claim 12 further comprising a storing unit for storing the verification code.
